(19) United States
(12) Patent Application Publication
(10) Pub. No.: US 2012/0213895 A1
(43) Pub. Date: Aug. 23, 2012

(54) ELIMINATING THE GENERATION OF MBT IN A HOPS BASED BEVERAGE

(75) Inventors: Jan Norager Rasmussen, Olstykke (DK); Steen Vesborg, Gentofte (DK)

(73) Assignee: CARLSBERG BREWERIES A/S

(21) Appl. No.: 13/505,728

(22) PCT Filed: Nov. 3, 2010
(86) PCT No.: PCT/EP2010/066690

§ 371 Date: May 2, 2012

(30) Foreign Application Priority Data
Nov. 3, 2009 (EP) 09174846.7

(51) Int. Cl. B65D 81/30; G02B 5/20; F25D 27/00; B65D 23/02; F25D 23/00

(52) U.S. Cl. 426/106; 215/379; 220/592.02; 359/361

(57) ABSTRACT

A bottle, container, or beverage glass for containing a hops-based beverage that includes a concentration between 10 μg/ and 10 mg/ of Riboflavin is at least partially transparent or translucent to visible light and has an optical filter characteristic preventing or reducing light transmission of wavelengths between 200 nm and 510 nm to a level preventing generation of more than a tasteable concentration of MBT in the beverage through photochemical reactions and photochemically initiated auto-catalytic reactions involving the Riboflavin. The tasteable concentration is between 1 ng/l and 35 ng/l, preferably between 5 ng/l and 25 ng/l, and more preferably 10 ng/l.

### CROSS-REFERENCE TO RELATED APPLICATION

This application is a national phase filing, under 35 U.S.C. §371(c), of International Application No. PCT/EP2010/066690, filed Nov. 3, 2010, and is related to US patent application, entitled “PREVENTING THE GENERATION OF MBT IN A HOPS BASED BEVERAGE”, Docket No. 606-241.101, Serial No. ______, filed on even date herewith, the disclosures of which are incorporated herein by reference in their entireties.

### FEDERALLY SPONSORED RESEARCH OR DEVELOPMENT

Not Applicable

### BACKGROUND

The present invention relates to eliminating the generation of MBT in a hops based beverage.

It is generally known and commonly observed that the flavour quality of some kind of food products may be compromised when the food product is exposed to light. In the brewing industry it has been known for centuries that light, and in particular sunlight, may negatively affect the flavour of many types of beers. The flavour in the beer resulting from the light exposure is therefore is commonly referred to as “lightstruck” flavour. The lightstruck flavour is considered by most beer consumers to be highly repulsive.

In “Y. Kuroiwa and H. Hashimoto, Studies on hops with reference to their role in the evolution of sunstruck flavour of beer, Rep. Res. Lab Kirin Brew. Co Ltd, 1961, 4, 35-40” it was found that only beers containing hops (Humulus lupulus L.) are susceptible to being lightstruck, whereas unhopped beers fail to develop any signs of being lightstruck. Consequently, the inclusion of hop-derived substances was found to be essential for the formation of the lightstruck flavour. Further, the same publication revealed that the presence in beer of isohumulones, five-membered-ring hop derivatives, are necessary for the formation of the lightstruck flavour. These compounds are not originally present in hops but are formed upon boiling of the wort with hops in the brewing kettle. In addition to the bittering of beers, isohumulones also account for bacteriostatic activity and are essential in stabilizing beer foam.

Riboflavin (vitamin B₂), and its spectroscopically equivalent derivates, e.g. flavin mononucleotide and flavin adenine dinucleotide, is ubiquitous in beer, as it is readily synthesized by yeast during fermentation, and is present in up to several hundreds of micrograms per liter. Structurally riboflavin consists of a highly conjugated 3-ringed hetero system, called an isoalloxazine ring which is responsible for the light absorbing properties of riboflavin and its derivates and an attached ribose moiety. Another feature characteristic of flavines including riboflavin and its derivates, is their ability to undergo reduction upon photoactivation, accepting hydrogen ions and one or two electrons. These reactions take place within the isoalloxazine ring.

In “Y. Kuroiwa, N. Hashimoto, H. Hashimoto, E. Kobuko and K. Nakagawa, Factors essential for the evolution of sunstruck flavour, Proc. Am. Soc. Brew. Chem, 1963, 181-193” model reactions have been carried out and have shown that photolysis with visible light (between 350 nm and up to 500 nm) of solutions containing a mixture of riboflavin (vitamin B₂) isohumulones, ascorbic acid and sulfur-containing amino acids will produce MBT.

A few prior art publications suggest measures and technologies for avoiding the generation of MBT. The above publication contemplated the addition of caramel to darken the beer in order to hinder or reduce the formation of MBT by way of energy scavenging from photo activated riboflavin or its derivates but found the effect insufficient.

In “C. Laane, G. de Roo, E. v.d. Ban, M-W Sjauw-En-Wa, M. G. Duyvis, W. A. Hagen, W. J. H v. Berkel, R. Hilhorst, B. J. M Schmedding and D. J. Evans, The Role of Riboflavin in Beer Flavor Instability: EPR studies and the application of flavin binding proteins, J. Inst. Brew., 1999, 105, p 392-397” it is shown, that in the presence of minute amounts of molecular oxygen, photoactivated riboflavin will not only act to form MBT, but also to form various staling aldehydes upon decomposition of isohumulones, which may give the beer a by-taste of cardboard. To counter this, the publication suggested the removal of riboflavin from the beer by the addition of egg white riboflavin binding protein or its apoform. Equimolar amounts of riboflavin and protein were found to be sufficient to hinder the formation of palatable amounts of MBT.

In recent years a significant amount of scientific work has been dedicated to elucidating the exact pathway through which MBT is formed in the presence of riboflavin or its derivatives. In “K. Huvaere, M. L. Andersen, M. Storme, J. v. Bocxlaer, L. H. Skibsted and D. de Keukeleire, Flavin-induced photodecomposition of sulfur-containing amino acids is decisive in the formation of beer lightstruck flavour, Photochem. Photobiol. Sci., 2006, 5, p 961-969” it is described how riboflavin (or one of its derivates) upon photo activation by light in the wavelength region between 350 nm to 500 nm becomes energetically exited in a triplet state (denoted ³RF*) which may subsequently oxidize available isohumulones. Such oxidized isohumulones are instable and decompose forming transient radicals which may react with sulfur containing amino acids, such as cysteine, thereby forming sulfur containing degradation products, including MBT. However, the publication is completely silent about any harmful effect of light outside the above mentioned 350-500 nm. Further, no advice on how to prevent lightstruck flavour in beer has been provided.

Further prior publication which may aid in the understanding of the generation of MBT include: “C. Lintner, in Lehrbuch der Bierbrauerei, Verlag Vieweg und Sohn, Braunschweig, Germany, 1875, p. 343”, “K. Huvaere, K. Olsen, M. L. Andersen, L. H. Skibsted, A. Heyerick and D. de Keukeleire, Riboflavin-sensitized photooxidation of isohumulones and derivatives,Photochem. Photobiol. Sci., 2004, 3, p 337-340”, “K. Huvaere, B. Sinnaeve, J. v. Bocxlaer and D. de Keukeleire, Photooxidative degradation of beer bittering principles: product analysis with respect to lightstruck flavour formation, Photochem. Photobiol. Sci., 2004, 3, p 854-858”, “M. G. Duyvis, R. Hilhorst, C. Laane, D. J. Evans and D. J. M Schmedding, Role of riboflavin in beer flavour instability: determination of levels of riboflavin and its origin in beer by fluorometric apoprotein titration.”, “L. Michaelis, M. P. Schubert and C. V. Smythe, Potentiometric Study of the Flavins, J. Biol. Chem., 1936, 116, p 587-607”, “C. Laane, G. de Roo, E. v.d. Ban, M-W Sjauw-En-Wa, M. G. Duyvis, W. A. Hagen, W. J. H v. Berkel, R. Hilhorst, B. J. M Schmedding and D. J. Evans, The Role of Riboflavin in Beer Flavor Instability: EPR studies and the application of flavin binding proteins, J. Inst. Brew., 1999, 105, p 392-397.”, and, “C. S. Burns, A. Heyerick, D. de Keukeleire and M. D. E. Forbes, Mechanism for Formation of the Lightstruck Flavor in Beer Revealed by Time-Resolved Electron Paramagnetic Resonance, Chem. Eur. J., 2001, 7, p 4553-4561.”

Within the technical field of beverage packaging and beverage dispensing, several technologies exist relating to the prevention of the formation of light-struck flavour, which technologies are described in, among others:

WO2006104387A1 (corresponding to US20080213442A1) discloses a composition to be used as an additive in beverages or foodstuffs to prevent or reduce light induced flavour changes. The composition is particularly suitable for beverages containing significant quantities of riboflavin. The reference further discusses a principal source of the lightstruck flavour in beer is 3-methyl-2-butene-1-thiol (3-MBT) which is believed to be formed by the reaction between light excited riboflavin and the iso-a-acids. Further, it is discussed that lightstruck formation in beer in general is promoted particularly strongly by light with a wavelength of 250-550 nm.

EP1675938B1 discloses another composition to be used as an additive in beverages or foodstuffs to prevent or reduce light induced flavour changes. See WO2006104387A1above.

WO2001092459A1 discloses a method to modify the original flavour or aroma of beer by exposing the beverage to a light source having a wavelength of between 350-500 nm to cause the beer to become light-struck. The deliberate irradiation of the beer causes the formation of 3-methyl-2-butene-1-thiol (MBT). The reference further states that it is believed that exposure to light in the UV (ultraviolet) region photosensitizes riboflavin (vitamin B2) which occurs naturally in beer. Energy from the activated riboflavin is then transferred to hop acids in the beer. A hop acid derived radical molecule is then thought to abstract a sulphydryl radical from one of the many sulphur containing species present in beer to produce MBT giving the beer the distinctive lightstruck flavour or aroma.

WO2008098937A1 discloses a method for fixing a valve assembly to a container. The reference further mentions that it is believed that the lightstruck flavour is due to photochemical changes assisted by the presence of the photo initiator riboflavin. A transmittance of less than 3% at wavelengths of between 560 nm and 300 nm is mentioned as being preferred.

U.S. Pat. No. 7,387,646B2 (and similar WO2008006722A2) discloses a method of protecting organic material from damage caused by daylight and artificial light using a pigment and optionally a UV absorber in a carrier material. The reference further mentions that foodstuffs such as beer contain vitamin B2 (riboflavin), which is known to be very sensitive to UV light as well as to daylight up to 500 nm.

US20040195141A1 (and corresponding European patent EP1483158B1) discloses a container for housing a product to be protected from light. The reference further mentions that the lightstruck flavour is generated by several phenomena including the conversion of vitamins, particularly a significant loss of water-soluble vitamins, for example riboflavin.

EP1737755B1 discloses packaging articles for storage of products such as milk. The reference further mentions that the taste of milk irradiated with UV light is mainly due to degradation of vitamins such as riboflavin and that it is radiation below 550 nm that appears to be responsible for the degradation and the altered taste.

EP1616695A1 discloses a heat shrinkable opaque white film perferably having a transmission factor to light at wavelengths of 380 to 500 nm of 5% or less. The heat-shrinkable opaque white film can prevent a beverage containing vitamins or beer from discoloration and deterioration.

JP2005220232A discloses a coating containing a first inorganic colorant that absorbs the light in the wavelength region of 450-520 nm. The coating effectively prevents a daylight smell and can preserve the freshness of beer.

WO1998007018A1 discloses a method of measurement of light transmittance. The reference further mentions that wavelengths of light of up to about 550 nm have the greatest impact on light struck flavour in beer. Wavelengths of light above about 550 nm, on the other hand, have little effect.

EP461537B1 discloses coating for protecting products in light-transmitting containers from lightstruck. The wavelength of the light blocked by the coating may be 300-525 nm.

WO2002094907A1 (and later WO2004041935A1) discloses amber coloured polyesters suitable for packaging blocking light over the wavelength ranges of from about 320-550 nm. The polyester is particularly suitable for packaging beer.

JP2006298456A discloses a beverage container having a shielding capability for a visible region with a wavelength of 500 nm or less for packaging fizzy alcoholic beverage.

EP1690900A1 (and correspondingly U.S. Pat. No. 7,473,468B2) discloses a colorant for a thermoplastic resin. The reference further mentions that beer containers should provide at least 96% blocking in an ultraviolet region of 420 nm or less and more than 70% blocking in a visible region in the vicinity of 550 nm for the stability of the contents.

JP2002201347A discloses a polyethylene terephthalate resin coloured composition screening harmful light at 400-500 nm.

JP2001279185A discloses a glass container covering material for beer bottles having a pigment for blocking rays having a wavelength of 450-550 nm.

WO1996032465A1 discloses a process for the production of a hopped malt beer wherein a processing liquid containing riboflavin subjected to actinic radiation, which decomposes the riboflavin, prior to hopping, results in a more light stable beer.

None of the above documents have been able to describe exact “critical” wavelengths for light for the formulation of MBT, nor has any of the documents treated the wavelength area outside the “critical” MBT generating wavelength range.

An object of the present invention is therefore to refine and improve the technologies for avoiding the generation of MBT in hops containing beverages including Riboflavin, typically beer.

An advantage of the present invention compared to prior art is the improved understanding of the chemical and physical phenomenon relating to lightstruck beverage and the ability to manufacture products having a more attractive colour than previously possible.

A particular feature of the present invention is the broad area of its application including beverage bottles, beverage containers, beverage glasses, beverage kegs, storage cases, refrigerators, lamps, etc.

### SUMMARY

The above object, the above advantage and the above feature together with numerous other objects advantages and features which will be evident from the below detailed description of preferred embodiments are according to a first aspect of the present invention obtained by a bottle, container or beverage glass for containing a hops based beverage, in particular beer, including a concentration between 10 □g/I and 10 mg/l of Riboflavin, the bottle, container or beverage glass being at least partially transparent or translucent to visible light and having an optical filter characteristic preventing light transmission of wavelengths between 200 nm and 510 nm to a level preventing generation of more than a tasteable concentration of MBT in the beverage through photochemical reactions and photochemically initiated auto-catalytic reactions involving the Riboflavin, the tasteable concentration being between 1 ng/l and 35 ng/l, preferably between 5 ng/l and 25 ng/l, and more preferably 10 ng/l.

It has been found out that the cause of the lightstruck flavour in beer relates to the presence of small amounts of the substance 3-methylbut-2-ene-1-thiol, also known as MBT, in the beer. MBT is highly odorous and repulsive even in very small quantities. Since the sense of taste varies between humans, the maximum amount of MBT which can be allowed for the beer to remain acceptable varies from person to person. It has been found out by the applicant company that even extremely low concentrations of MBT may yield an unpleasant taste for some beer consumers. The numerical values of concentrations which are detectable by humans may be as low as a few ppt (parts-per-trillion), or alternatively a few ng/l. Such small concentration values may be measured by e.g. gas chromatographic methods. In the present context it should be pointed out that variations between different kinds of beer and the reliability of the taste panels may lead to varying evaluations of the taste of the beer and thus an exact limit of the concentration of MBT, where the beer is still tolerable, is difficult to determine. It is contemplated that some people may find the beer intolerable only at much higher concentrations of MBT. Some people may even be incapable of sensing MBT at all. To find out the concentration of MBT which is still acceptable to most people, a so called triangular test, also known as triangle test or triangular tasting test, has been performed.

A triangular test is performed by arranging a setup of three beverage samples where two of the beverage samples are similar and the third beverage sample is different from the other two beverage samples. For example, two of the beverage samples contain a beverage, such as a beer, essentially without any MBT contamination, and the third beverage sample contains the same beverage being contaminated by a specific concentration of MBT. Alternatively, two of the beverage samples may contain the beverage contaminated by MBT, and the third beverage sample may be MBT free. The beverage samples are provided to a group of professional beverage tasters having the task of selecting the beverage sample containing the beverage being different from the other two samples, regardless of it being a MBT contaminated or non-MBT-contaminated beverage sample. In case a majority of the tasters can identify the beverage sample being different, the specific concentration of MBT used for the test is considered to be a tasteable concentration, In the present context is should be noted that the tasteable concentration may be different between different kinds of beverage, and certain additives to the beverage may camouflage the taste of MBT making it undetectable to the beverage tasters. It should also be noted that there are several known error factors which may influence the result of the triangular test, and therefore the tests are typically repeated a number of times to achieve a statistically accurate result. The applicant company has performed extensive tests of many different kinds of beer and has been able to determine tasteable limits of between 1 ng/l and 35 ng/l. Some more testing narrowed the limits to between 5 ng/l and 25 ng/l depending on the kind of beer. Particular beer of the lager type and produced by the applicant company was used for testing, and a MBT contamination of 10 ng/l was used in the contaminated beverage samples. The result was that six out of ten tasters were capable of determining which beverage sample was different. Out of the six tasters being able to determine the different beverage samples, five out of the six judged that the non-contaminated sample had the most preferable taste. Only one taster judged that the MBT contaminated sample had the most preferable taste. The applicant therefore has concluded that up to 10 ppt, or 10 ng/l, of MBT may be allowed in the beer for the beer to remain acceptable to a vast majority of the beer consumers of the general public.

The previously assumed irradiation wavelength limit for generation of MBT of around 500 nm has proved to be insufficient, since it has been found out by the applicant company that MBT may be produced also above 500 nm to an extent making the beverage unacceptable. Recent research performed by the applicant company has determined a very sharp decrease in fluorescence reaction and photo activation of MBT at wavelengths of above 510 nm. It has been found out that photons having wavelengths above 510 nm do not have sufficient energy to initiate any of the previously described photochemical reactions leading to the generation of MBT. For avoiding the generation of MBT, it is desirable that the bottle, container or beverage glass therefore eliminate transmission of light wavelengths in the range from 200 nm up to 510 nm. It is therefore suggested to use optical filter characteristics having a very sharp transition at 510 nm between its substantially transparent wavelength range above 510 nm and its substantially non-transparent wavelength range below 510 nm.

The generation of MBT has been shown to be essentially linear with respect to the light intensity. During transport and storage the beverage bottle or container may be subjected to both indoor and outdoor light. For instance, when the beverage bottle or container is carried from a truck into a warehouse, or from a supermarket to a private home, the bottle will typically be subjected to outdoor light for at least as many minutes as it takes the beverage supply person to move the beverage bottle or container between the above mentioned sites. Inside a warehouse the beverage bottles or containers should endure at least a week of indoor light, preferable more, before MBT levels are above the critical 10 ppt, or 10 ng/l, which has been found to be the limit at which the beverage is still acceptable for drinking. The bottle or container should be transparent, or at least translucent, to some wavelength or wavelengths above 510 nm to allow the user to inspect the beverage inside the bottle, and in particular determine the level of remaining beverage.

It has also be found out that the MBT generation is the result of both photochemical reactions and photochemically initiated autocatalytic reactions. Whereas the photochemical reactions stop when the beverage is removed from sunlight, the autocatalytic reactions may continue even after the bottle or container has been removed from sunlight and the autocatalytic reaction may continue to produce MBT for several hours and even days after the beverage has been exposed to sunlight. The applicant has performed tests where a beverage sample has been stored in a lit cabinet for 3 days without experiencing any tasteable light-struck flavour. After storing the same sample for another 3 days in a dark cabinet, light-struck flavour was determined to have reached a tasteable level.

The beverage glass according to the first aspect of the present invention has similar properties as the bottle or container according to the first aspect. The beverage glass has a large upwardly opening and is preferably only used during the relatively short time period of the consumption of the beverage. It may be contemplated that the beverage glass must protect the beverage for a shorter time, however, it will possibly have to endure higher sunlight intensity, e.g. when the beverage is consumed outdoors.

According to a further embodiment of the present invention, the bottle, container or beverage glass comprises an outer wall having an inwardly facing surface, and an inner wall constituting a coating of the inwardly facing surface, the outer wall being at least partially transparent or translucent and at least substantially rigid, the inner wall being at least partially transparent or translucent and having the optical filter characteristics. The inner wall should be non-toxic, gas-proof and waterproof, since it will contact the beverage.

According to a still further embodiment of the present invention, the bottle, container or beverage glass comprises an inner wall having an outwardly facing surface, and an outer wall constituting a coating of the outwardly facing surface, the inner wall being at least partially transparent or translucent and at least substantially rigid, the outer wall being at least partially transparent or translucent and having the optical filter characteristics. The outer coating should preferably be durable, however, it is not necessary that the outer coating be non-toxic, gas-proof and waterproof.

The above object, the above advantage and the above features together with numerous other objects advantages and features which will be evident from the below detailed description of preferred embodiments are according to a second aspect of the present invention obtained by a hops based beverage, in particular beer, including a concentration between 10 □g/l and 10 mg/l of Riboflavin, the beverage being at least partially transparent or translucent to visible light and including a constituent having an optical filter characteristic preventing light transmission of wavelengths between 200 nm and 510 nm to a level preventing generation of more than a tasteable concentration of MBT in the beverage through photochemical reactions and photochemically initiated auto-catalytic reactions involving the Riboflavin, the tasteable concentration being between 1 ng/l and 35 ng/l, preferably between 5 ng/l and 25 ng/l, and more preferably 10 ng/l.

The constituent may e.g. be a colorant included in the beverage. Alternatively, flakes and/or nano-particles and/or colloid material can be used. It is evident that the constituent must be non-toxic and flavourless, since it would be dissolved or mixed in the beverage. In addition to protecting the beverage from lightstruck flavour, there might be a commercial interest in providing beverages having an unusual colour, e.g. a green beer etc.

The above object, the above advantage and the above features together with numerous other objects advantages and features which will be evident from the below detailed description of preferred embodiments are according to a third aspect of the present invention obtained by a refrigerator for storing hops based beverage being stored in beverage bottles, the refrigerator having a door and an optional internal light source, the beverage including a concentration between 10 □g/l and 10 mg/l of Riboflavin, the door and optional light source being at least partially transparent or translucent to visible light and having an optical filter characteristic preventing light transmission of wavelengths between 200 nm and 510 nm to a level preventing generation of more than a tasteable concentration of MBT in the beverage through photochemical reactions and photochemically initiated auto-catalytic reactions involving the Riboflavin, the tasteable concentration being between 1 ng/l and 35 ng/l, preferably between 5 ng/l and 25 ng/l, and more preferably 10 ng/l.

Although many professional beverage producers and providers have identified the problem of light-struck beverage, many supermarkets, bars etc. have not. It is therefore frequently observed that Riboflavin containing beverages such as beer is stored in transparent and often well lit refrigerators for the customers to see the drink without opening the refrigerator door. Some of the above mentioned establishments are open 24 h every day and thus expose the beverage to harmful light permanently. To avoid the beverage being affected by lightstuck flavour, the transparent refrigerator door and the optional light sources may be covered by a coating, film or the like, having the previously mentioned specific optical filter characteristics, or alternatively, the transparent door and the light sources may have the specific optical filter characteristics inherently thereby substantially eliminating light frequencies below 510 nm.

The above object, the above advantage and the above feature together with numerous other objects advantages and features which will be evident from the below detailed description of preferred embodiments are according to a fourth aspect according to the present invention obtained by a packaging film for protecting hops based beverage being stored in beverage bottles, the beverage including a concentration between 10 □g/l and 10 mg/l of Riboflavin, the packaging film being at least partially transparent or translucent to visible light and having an optical filter characteristic preventing light transmission of wavelengths between 200 nm and 510 nm to a level preventing generation of more than a tasteable concentration of MBT in the beverage through photochemical reactions and photochemically initiated auto-catalytic reactions involving the Riboflavin, the tasteable concentration being between 1 ng/l and 35 ng/l, preferably between 5 ng/l and 25 ng/l, and more preferably 10 ng/l.

Such packaging film may be provided for several different purposes such as covering beverage cases during transport and storage. It is evident that the packaging film may be used also for other purposes than covering beverage bottles or beverages, e.g. covering other food products such as milk, cheese, olive oil or the like.

According to a further embodiment of the present invention the bottle, container, beverage glass, beverage, refrigerator or packaging film, generation of more than a tasteable concentration of MBT in the beverage is prevented when the bottle, container, beverage glass, beverage, refrigerator or packaging film is irradiated by sunlight having an intensity of 1 kW/m² during a time-period of at least 15 minutes, such as between 30 minutes and 1 hour, preferably at least 2 hours, more preferably at least 5 hours and most preferably at least 1 day.

The sunlight irradiation may reach levels up to 1 kW/m² outdoors under very bright circumstances. Such special circumstances may include the sun being in zenith and substantially no clouds or other atmospheric effects obscuring the solar light. It is also contemplated that solar activities such as sunspot activity may cause the sunlight intensity to vary. Indoor sun intensity varies, and typical values are about 5-25 W/m². In the present context 1 kW/m² of sunlight is used as a reference, indicating the “worst case”, since 1 kW/m² is contemplated to be near the maximum sunlight intensity occurring on the surface of the planet earth. Sunlight is here to be understood in its broadest sense, and may also include artificial light sources, although most artificial light sources have an emission spectrum different from that of the sun. Many artificial light sources have the same negative effect on riboflavin containing beverage as sunlight has.

It is evident that different time periods, i.e. different long minimum protection times, may be required for different applications. Generally, professional establishments have a higher turnover of beverage, and thus would generally be requiring a shorter protection time than private users who may store the beverage a longer time before consumption. Also, professional users may know about the lightstruck effect and thus be able to store the beverage in a basement or similar dark place, whereas private users may store the beverage in more lit places due to lack of space or lack of knowledge. Also, a glass will only be used during drinking, thus will probably only need to protect the beverage for about 10-20 minutes, however possibly subjected to very intense light. A refrigerator must also be able to protect the beverage during the time until the beverage is sold to a customer, which may be a few days under at least moderate sunlight intensity. The container or bottle must protect the beverage over its full useful lifetime, which may range from days to several weeks or even more. It is evident that the sunlight intensity plays a big role in determining the minimum time period of protection, such that the beverage may be stored either a long time period subjected to a low amount of sunlight, or alternatively a short time period subjected to a high amount of sunlight.

According to a further embodiment of the present invention the bottle, container, beverage glass, beverage, refrigerator or packaging film, generation of more than a tasteable concentration of MBT in the beverage is prevented when the bottle, container, beverage glass, beverage, refrigerator or packaging film, subsequent to being irradiated by sunlight, being stored in a non-irradiated location for at least 1 hour, preferably at least 5 hours, more preferably at least 1 day and most preferably at least 3 days.

As discussed above, the generation of MBT is caused by both photochemical reactions and photochemically initiated auto-catalytic reactions. After being photochemically initiated by irradiation of sunlight of wavelengths between 200 nm and 510 nm, the auto-catalytic reactions may continue regardless of the exposure to sunlight or not. Thus, the beverage may exhibit little or non-tasteable levels of MBT directly after sunlight irradiation and unacceptable levels of MBT after being stored for a time period. Thus, for allowing a storage time of the beverage, the concentration of MBT should be determined to be lower than tasteable levels after the irradiation time and the subsequent time of non-irradiated storage time. Depending on the situation, storage times of 1 hour up to several days or more are considered to be appropriate.

According to a further embodiment of the present invention the bottle, container, beverage glass, beverage, refrigerator or packaging film, the bottle, container, beverage glass, beverage, refrigerator or packaging film allows light transmission of wavelengths in the wavelength range between 200 nm and 510 nm, at a transmission ratio of no more than 10%, preferably no more than 5%, more preferably no more than 1% and most preferably no more than 0.5%.

The applicant company has found out that it is desirable to only allow a very small percentage of light transmission in the whole critical wavelength area to prevent generation of a tasteable level of MBT. The results of the investigation of the applicant company show that a transmission ratio of no more than 10% is desirable for most types of beer, depending on the presumed light intensity and the intended time of light exposure and storage. Some beers have shown to require additional protection, such as 5%, 1% or 0.5% maximum transmission over the whole critical frequency range.

According to a further embodiment of the present invention the bottle, container, beverage glass, beverage, refrigerator or packaging film allows light transmission of at least one wavelength or one wavelength range within the wavelength range between 510 nm and 750 nm, at a relative transmission ratio of at least 50% as compared to the transmission through air, preferably 75%. To be able to see the beverage sufficiently through the bottle, container, beverage glass, beverage, refrigerator or packaging film, even during low light conditions it is preferred to allow a large amount of light having frequencies above 510 nm through. It has been shown that 50% light transmission is sufficient for an acceptable identification of the beverage, however, 75% light transmission may be preferred, especially in low light situations.

According to a further embodiment of the present invention the bottle, container, beverage glass, beverage, refrigerator or packaging film allows light transmission of wavelengths in the wavelength range between 575 nm and 750 nm, at a relative transmission ratio of no more than 20% as compared to the transmission through air, preferably no more than 10%. By allowing at least 50% transmission of the green wavelength and only 20%, or preferably 10%, transmission in the rest of the spectrum above 510 nm, the bottle, container, beverage glass, beverage, refrigerator or packaging film will appear green. Green is the most popular and well known colour in relation to beer bottles, and may thus be preferred by most producers due to commercial reasons.

According to a further embodiment of the present invention the bottle, container, beverage glass, beverage, refrigerator or packaging film allows light transmission of wavelengths in the wavelength range between 510 nm and 575 nm and between 625 nm and 750 nm, at a relative transmission ratio of no more than 20% as compared to the transmission through air, preferably no more than 10%. By allowing at least 50% transmission of the yellow wavelength and only 20%, or preferably 10%, transmission in the rest of the spectrum above 510 nm, the bottle, container, beverage glass, beverage, refrigerator or packaging film will appear yellow. Yellow is an unusual colour in relation to beverage bottles, and may thus be occasionally used due to commercial reasons.

According to a further embodiment of the present invention the bottle, container, beverage glass, beverage, refrigerator or packaging film allows light transmission of wavelengths in the wavelength range between 510 nm and 625 nm and between 675 nm and 750 nm, at a relative transmission ratio of no more than 20% as compared to the transmission through air, preferably no more than 10%. By allowing at least 50% transmission of the orange wavelength and only 20%, or preferably 10%, transmission in the rest of the spectrum above 510 nm, the bottle, container, beverage glass, beverage, refrigerator or packaging film will appear orange. Orange is an unusual colour in relation to beverage bottles, and may thus be occasionally used due to commercial reasons.

According to a further embodiment of the present invention the bottle, container, beverage glass, beverage, refrigerator or packaging film allows light transmission of wavelengths in the wavelength range between 510 nm and 675 nm, at a relative transmission ratio of no more than 20% as compared to the transmission through air, preferably no more than 10%. By allowing at least 50% transmission of the red wavelength and only 20%, or preferably 10%, transmission in the rest of the spectrum above 510 nm, the bottle, container, beverage glass, beverage, refrigerator or packaging film will appear red. Red is an unusual colour in relation to beverage bottles, and may thus be occasionally used due to commercial reasons.

According to a further embodiment of the present invention the bottle, container, beverage glass, beverage, refrigerator or packaging film allows light transmission of wavelengths in the wavelength range above 750 nm, at a relative transmission ratio of no more than 20% as compared to the transmission through air, preferably no more than 10%. The above embodiment will yield a bottle, container, beverage glass, beverage, refrigerator or packaging film which will prevent most of the infrared radiation over 750 nm to pass through, and thereby help keeping the beverage cool when subjected to sunlight.

The above object, the above advantage and the above features together with numerous other objects advantages and features which will be evident from the below detailed description of preferred embodiments are according to a fifth aspect of the present invention obtained by a method comprising:

providing a bottle, container, beverage glass, beverage, refrigerator or packaging film, the bottle, container, beverage glass, beverage, refrigerator or packaging film being at least partially transparent or translucent to visible light and having an optical filter characteristic preventing light transmission of wavelengths between 200 nm and 510 to a level preventing generation of more than a tasteable concentration of MBT in the beverage through photochemical reactions and photochemically initiated auto-catalytic reactions involving the Riboflavin, the tasteable concentration being between 1 ng/l and 35 ng/l, preferably between 5 ng/l and 25 ng/l, and more preferably 10 ng/l, and filling the bottle, container, beverage glass, beverage, refrigerator or packaging film by the hops based beverage.

It is evident that the above filling method according to the fifth aspect may be used together with any of the embodiments according to the first to fourth aspect.

### BRIEF DESCRIPTION OF THE DRAWINGS

The present invention is now to be further described with reference to the drawings, in which

FIG. 1 is a beer bottle having an outer layer having electromagnetic filter characteristics.

FIG. 2 is a beer bottle having an inner layer having electromagnetic filter characteristics.

FIG. 3 is a beer keg having an outer layer having electromagnetic filter characteristics.

FIG. 4 is a beer crate being sealed by a film having electromagnetic filter characteristics.

FIG. 5 is a refrigerator having a door having electromagnetic filter characteristics.

FIG. 6 is the molar extinction coefficient and the generated MBT for different wavelengths of light.

FIG. 7 is the linear relationship between the generation of MBT and the light exposure level.

### DETAILED DESCRIPTION

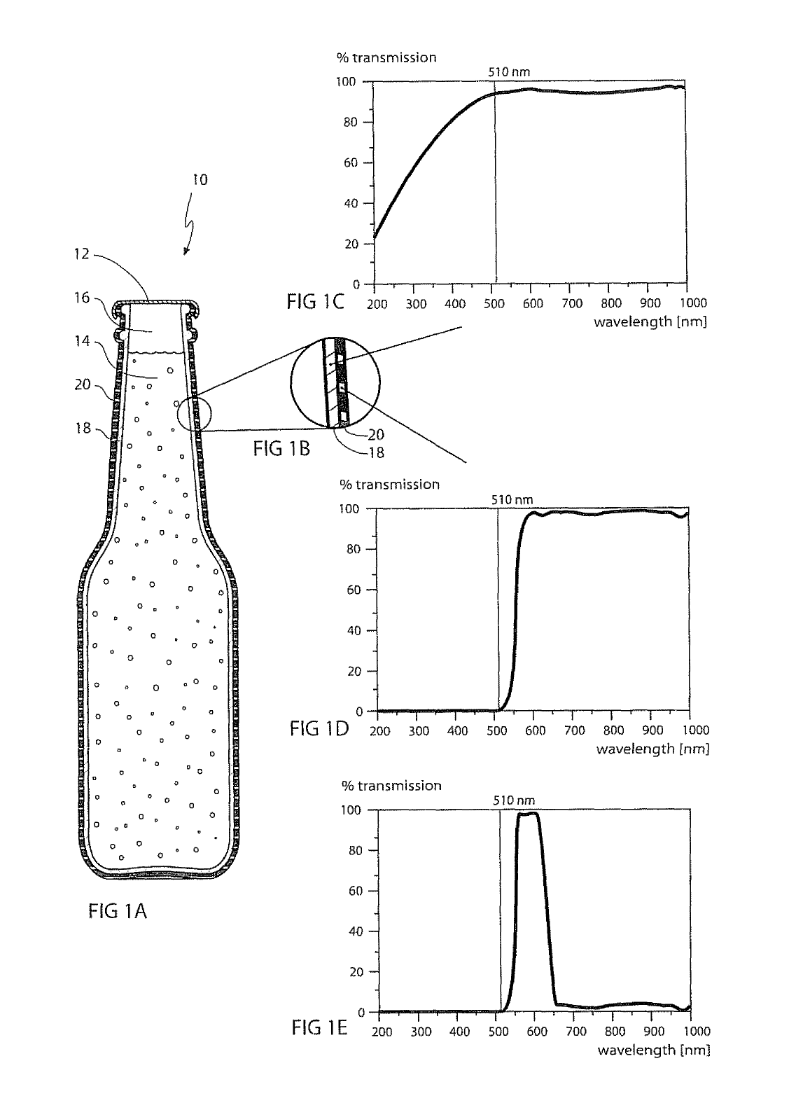

FIG. 1a shows a bottle 10 which is sealed by a cap 12. The bottle 10 contains beer 14 and a small head space 16. The bottle 10 has an inner wall 18, which is made of glass, and an outer wall 20, which constitutes a polymeric coating or film having a specific optical filter characteristic, which will be explained in detail below.

FIG. 1b shows a close-up view of a section of the bottle 10. The inner wall 18 comprises a rigid layer of transparent glass. The thickness of the inner wall 18 may preferably be in the mm range and should be sufficiently rigid for allowing the bottle 10 to retain its shape when it is filled with beer. The inner wall 18 is covered by an outer wall 20, which is constituted by a partially transparent coating or film. The outer wall 20 may have any thickness, however, preferably the outer wall 20 is a thin coating in the mm or sub mm range. The outer wall 20 may optionally be provided with markings indicating the brand name and type of beer, however, such information may be provided on a separate sticker which is attached to the outer wall 20 as well. The inner wall 18 and the outer wall 20 have different optical filter characteristics, which will be explained in detail below.

FIG. 1c shows a diagram of typical optical filter characteristics of the transparent inner wall 18 of the bottle 10. The inner wall 18 is here shown to transmit about 90% of the incoming light from the outside the bottle 10 to the beer 14 inside the bottle 10 for all visible wavelengths and near infrared wavelengths, i.e. wavelengths from about 350 nm up to about 1000 nm. The light transmission of the inner wall 18 typically decreases in the UV wavelength range, i.e. at wavelengths below 350 nm. It should be noted that the light transmission in the UV range may vary depending on the type of glass. While most glass will prevent UV transmission, some kinds of glass, e.g. quarts glass, may have a higher transmission of UV light. It is of course contemplated that depending on the kind of material chosen for the inner wall 18, the transmission may differ. In some cases, the inner wall 18 may transmit less than 80% of the incoming light.

FIG. 1d shows a first embodiment of an optical filter characteristic of the outer wall 20 of the bottle 10. The outer wall 20 prevents light transmission of all wavelengths below 510 nm sufficiently for preventing unacceptable amounts of MBT to be generated in the beer through photochemical reactions involving the Riboflavin when the bottle is exposed to a certain amount of radiation. It is contemplated that some amount of radiation will pass the outer wall, however, the amount of MBT which is generated should not exceed 10 ng/l, which has been determined to be the limit at which an experienced beer taster may detect the presence of MBT. The outer wall 20 of the bottle 10 should be able to withstand at least 30 minutes or more of very intense sunlight of about 1 kW/m² before the critical amount of 10 ng/l of MBT is reached. Preferably and depending on the needs of the user and also on the geographical location of the user, the outer layer 20 of the bottle 10 should be able to withstand more than 30 minutes before 10 ng/l of MBT has been generated. It is of course contemplated that the shape of the bottle 10 may play a role as well for the generation of MBT, since the larger the area of the beer exposed to the light, the more MBT will be produced per unit of volume of beer.

The outer wall 20 should allow light of all wavelengths above 510 nm to pass through unaffected, or nearly unaffected. The visual light which is allowed to pass thru the outer wall 20 thus has the colours green, yellow and red. The bottle 10 having the above filter characteristics of the outer wall 10 will have a brownish colour when irradiated by sunlight. Brown bottles are common and mostly accepted for beer by the public.

The filter is achieved by a polymeric coating being made of a material including a light absorbing constituent, such as flakes, nano-particles, colloid material etc. One such material is produced by the company TOYO INK™ of Japan, and described in the European patent application EP 1 690 900.

FIG. 1e shows a second embodiment of an optical filter characteristic of the outer wall 20 of the bottle 10. The outer wall 20 prevents light transmission of all wavelengths below 510 nm sufficiently to allow the beer 14 to remain uncontaminated by MBT, i.e. a MBT generation of less than 10 ng/l during the specified amount of time, similar to the optical filter characteristic of FIG. 1d. In addition to the optical filter characteristic of FIG. 1d, the outer wall 20 of the present embodiment of the present invention prevents substantially all light transmission of all wavelengths above about 600 nm. The outer wall 20 having the filter characteristic of FIG. 1e allows light of all wavelengths between 510 nm and about 600 nm to pass unaffected, or nearly unaffected, through the outer wall 20. The visual light which is allowed to pass thus has the colour green. The above optical filter characteristics of the outer wall 20 will thus cause the bottle to assume a green colour when irradiated by sunlight. The green colour is for commercial purposes considered particularly useful for beer bottles, since beer consumers are used to green beer bottles and green bottles are very popular. It is in the present context evident that some producers may wish to have beer bottles of other colours, e.g. for a commercial event or happening or the like. The optical filter characteristics may thus be changed accordingly, e.g. allowing light transmission of wavelengths between 575 nm and 625 nm for a yellow bottle, between 625 nm and 675 nm for an orange bottle or between 675 nm and 750 nm for a red bottle. It may also be contemplated that the outer wall 20 may allow visible light between 510 nm and 750 nm for, in addition to blocking the harmful wavelengths below 510 nm, IR wavelength above 750 nm are blocked as well.

Concerning FIG. 1, the inner wall 18 is preferably transparent to all wavelengths of visible light, however, the inner wall 18 may also be coloured, thus transmitting only a single wavelength or single wavelength band. The inner wall 18 may alternatively be made of rigid or semi rigid transparent polymeric material such as plastic. Semi-rigid should in the present context be understood to mean that the bottle 10, when empty, may be collapsible. It is also feasible to use a unitary wall having the specific optical characteristics, e.g. a wall made of a polymeric material or glass having a constituent, e.g. flakes, nano-particles, colloid material or the like, of a material having the specific optical filter characteristics, i.e. eliminating wavelengths below 510 nm. It is in the present context evident that the above technology may be used for other kinds of beverage containers, such as cans and beer glasses. Having a coating as described above in connection with a beer glass will prolong the quality of the beer, in particular when being served outdoors, since harmful light of wavelengths below 510 nm may then only enter from the open top of the beer glass.

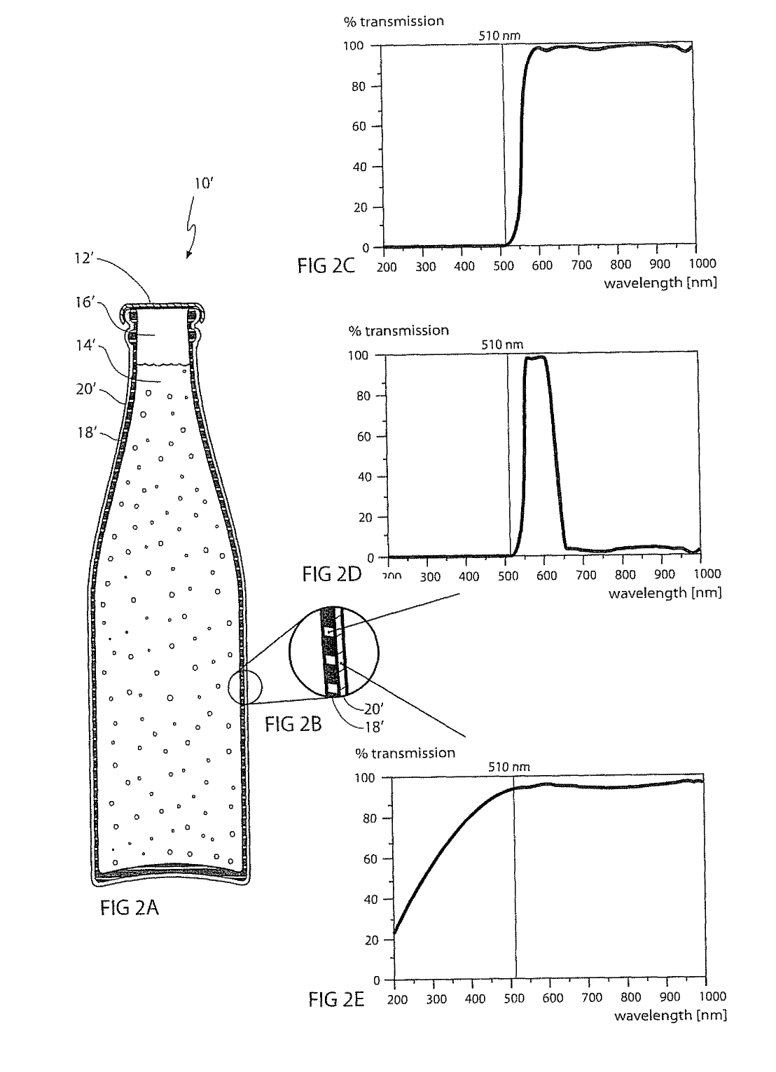

FIG. 2a shows a bottle 10′ similar to the bottle 10 of FIG. 1a. The bottle 10′ has an outer wall 20′, which is made of glass, and an inner wall 18, which constitutes a polymeric coating or film having a specific optical filter characteristic, which will be explained in detail below.

FIG. 2b shows a close-up view of a section of the bottle 10′ similar to FIG. 1b. The outer wall 20′ may thus have the same features at the inner wall 18 of FIG. 1b. The inner wall 18′ may be applied as a coating or film inside the bottle 10′, similar to the outer wall 20 of FIG. 1b. It should be noted that the inner wall 18′ should be non-toxic, gas-proof and waterproof, since it will be in direct contact with the beer 14′.

FIG. 2c shows a first embodiment of an optical filter characteristic of the inner wall 18′ of the bottle 10′. The characteristics of the inner wall 18′ are similar to the outer wall 20 of the bottle 10 of FIG. 1d.

FIG. 2d shows a second embodiment of an optical filter characteristic of the inner wall 18′ of the bottle 10′. The characteristics of the inner wall 18′ are similar to the outer wall 20 of the bottle 10 of FIG. 1e.

FIG. 2e shows a diagram of a typical optical filter characteristic of the transparent outer wall 20′ of the bottle 10′. The characteristics of the outer wall 20′ are similar to the inner wall 18 of the bottle 10 of FIG. 1c.

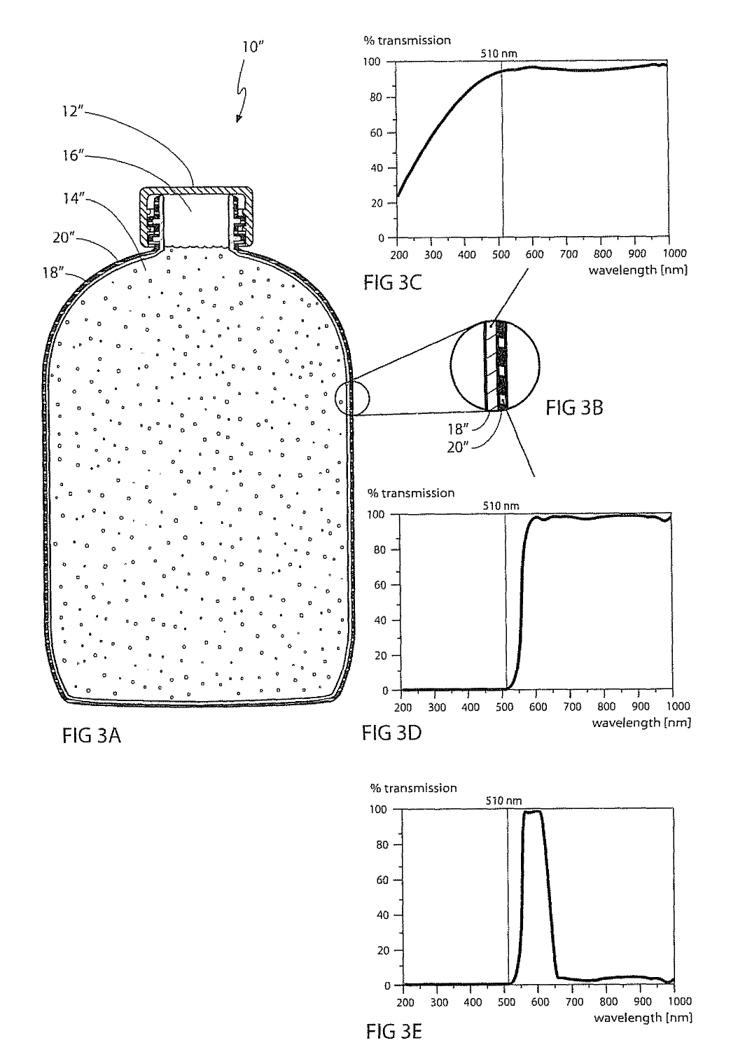

FIG. 3a shows a collapsible keg 10″ containing 5-50 litres of beer 14″. The keg 10″ is intended for use in a beverage dispensing system such as the DraughtMaster™ system produced by the applicant company. The keg 10″ has a cap 12″. The keg 10″ has an inner wall 18″, which is made of flexible polymeric material such as plastic, and an outer wall 20″, which constitutes a polymeric coating or film having a specific optical filter characteristic, which will be explained in detail below.

FIG. 3b shows a close-up view of a section of the keg 10″ similar to FIG. 1b. The inner wall 18″ may thus have the same features at the inner wall 18 of FIG. 1b, except being made of flexible polymeric material instead of glass. The inner wall 18″ should be sufficiently rigid to support the weight of the keg 10″. The outer wall 20″ is a coating or film applied outside the keg 10″, similar to the outer wall 20 of FIG. 1b.

FIG. 3c shows a diagram of a typical optical filter characteristic of the transparent inner wall 18″ of the keg 10″. The characteristics of the inner wall 18″ are similar to the inner wall 18 of the bottle 10 of FIG. 1c.

FIG. 3d shows a first embodiment of an optical filter characteristic of the outer wall 20″ of the keg 10″. The characteristics of the outer wall 20″ are similar to the outer wall 20 of the bottle 10 of FIG. 1d.

FIG. 3e shows a second embodiment of an optical filter characteristic of the outer wall 20″ of the keg 10″. The characteristics of the outer wall 20″ are similar to the outer wall 20 of the bottle 10 of FIG. 1e.

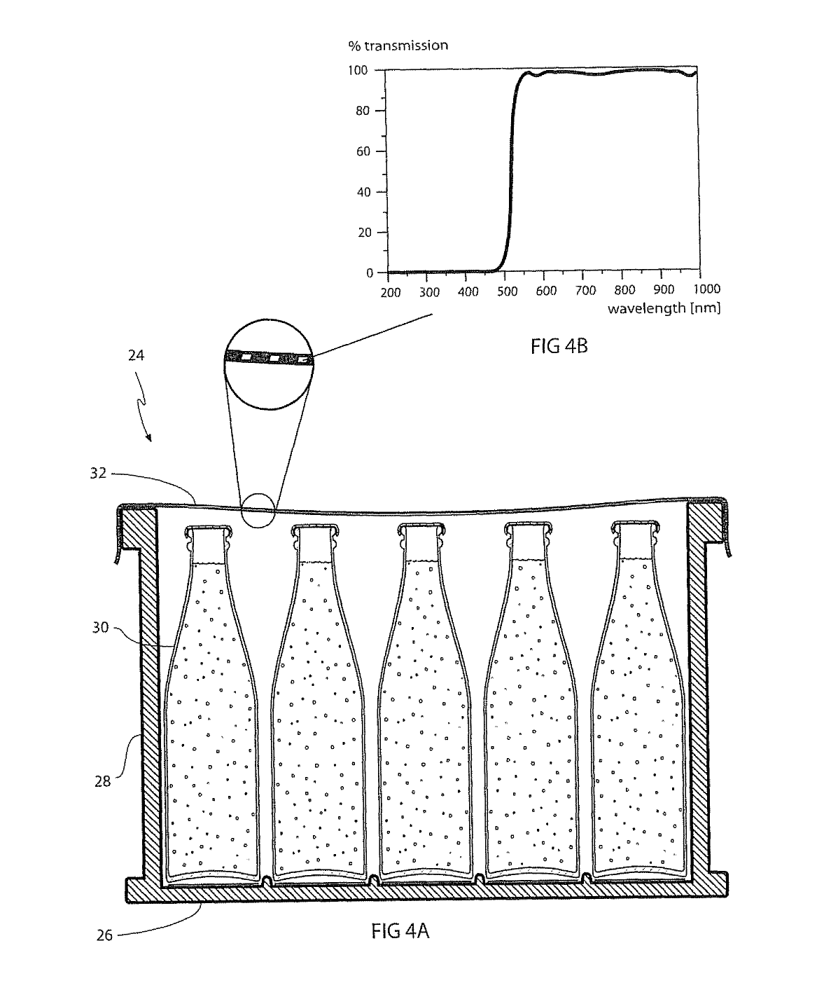

FIG. 4a shows a beverage case 24 made of non-transparent plastics having a bottom wall 26 and four sidewalls 28. The beverage case 24 is containing a plurality of standard beer bottles 30. The beer bottles 30 may be fully or largely transparent for all wavelengths, i.e. having optical filter characteristics similar to the inner wall designated 18 of FIG. 1.

Alternatively, the beer bottles 30 may be of the standard green or brown type. The upper part of the beverage case 24 is sealed by a protective packaging film 32 having an optical filter characteristic which will be explained in detail below.

FIG. 4b shows the optical filter characteristics of the packaging film 32, which are similar to the outer wall of FIG. 1d. By having such optical filter characteristics eliminating harmful light below 510 nm, ordinary (unprotected) beverage bottles 30 may be protected from harmful light during transport and storage. The protective packaging film 32 may e.g. be of the tear-off type, and allows the user to see the beer bottles from the outside. When a user desires a beer, the protective packaging film 32 may be removed, a beer bottle 30 may be obtained from the beverage case 24 and the protective packaging film 32 may preferably be re-applied for continuous protection of the remaining beers. The film 32 may be used on existing standard beverage cases, thus no new infrastructure must be purchased for applying this technology.

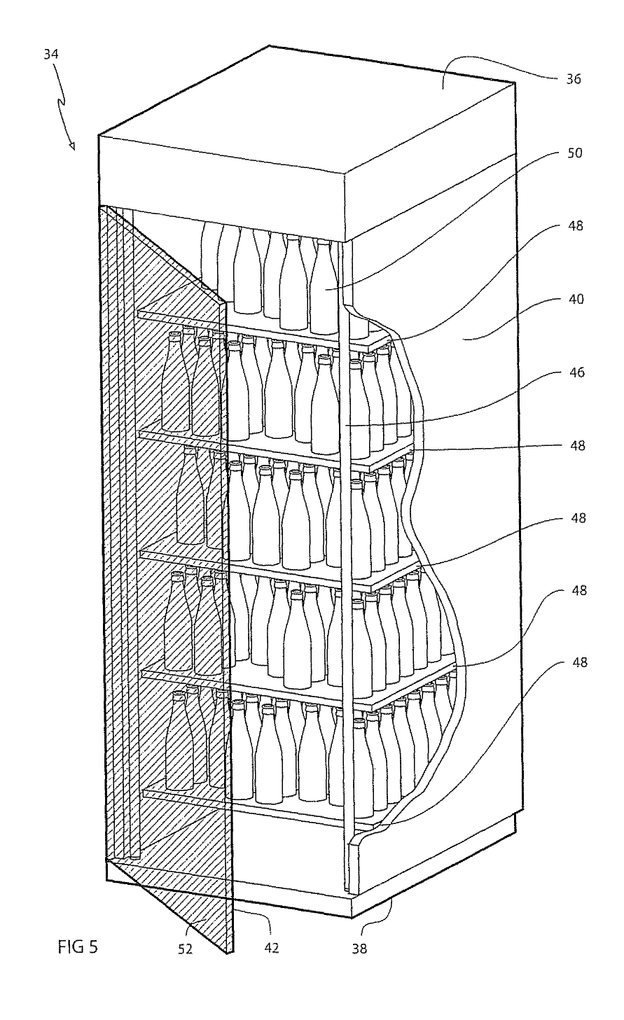

FIG. 5 shows a refrigerator 34 having a top 36, a bottom 38, three sidewalls 40 and a door 42, defining a chilled space therein. The chilled space of the refrigerator 34 may optionally be lit by a pair of light sources 46 located inside the chilled space 44. A plurality of shelves 48 are located inside the chilled space of the refrigerator 34. Several beer bottles 50 are located on the shelves 48. The door 42 has a transparent surface 52, such as a glass surface. Such refrigerators as described above are common in many commercial establishments. The present transparent surface 52 is further having an optical filter characteristic similar to the film 32 described in FIG. 4. The transparent surface 52 will thus prevent light having wavelengths below 510 nm from entering the refrigerator and affect the beverage, while a person, such as a customer or employee, may still see the beverage bottle from the outside the refrigerator 34.

In this way the refrigerator 34 may be placed outside on a sunny day, e.g. for use during a festival or for an open-air café. The refrigerator 34 may also be used for indoor establishments e.g. in supermarkets, petrol-stations, bars, restaurants and warehouses where prolonged exposure to artificial light sources may have the same negative effect on the beverage as sunlight will have. Preferably, the light source 46 may also have an optical filter characteristic similar to the transparent surface 52, especially in case the light sources 46 are always on, which is often the case for commercial establishments, since having the light sources operating at all times will expose the bottle better to the customer.

The applicant company has in the present context made light measurements in supermarkets, in warehouses and outdoors. Whereas the irradiation indoors range from about 25 W/m² near the roof of a well lit warehouse to about 7 W/m² at the floor level of the same well lit warehouse, the irradiation outdoors may be as high as 1000 W/m² e.g. at midday on a cloud free day near the terrestrial equator. However, while the storage outdoors may be discouraged and limited to the transportation between facilities and establishments such as production plants, warehouses, supermarkets, pubs, bars, restaurants and private homes, the indoor storage time may be extensive and unavoidable. For the present example a typical warehouse having small windows near the roof has been used. It is contemplated that a similar irradiation may be obtained by artificial light sources, such as light bulbs and fluorescent lamps. Accordingly, irradiation inside a refrigerator of a supermarket will vary depending on the distance to the transparent door and the distance from the internal light source, if any. Experiments made by the applicant company show that for a typical refrigerator having an internal light source near the transparent door, the irradiation varies between 0 at the back of the refrigerator to over 120 W/m² near the light-source and the transparent door. The differences are due to the fact that beer bottles located at the back of the refrigerator will be at least partially obscured by the beer bottles located in the front of the refrigerator, i.e. close to the door.

For practical reasons it has been considered that the beer should be able to withstand at least 30 minutes of intense sunlight. According to the above, 30 minutes of intense sunlight then corresponds to a minimum storage time in a warehouse of about 20 hours, which may be suitable for e.g. kegs for professional establishments having a high turnover. For private consumers, 60-120 minutes of intense sunlight, corresponding to a minimum storage time of 3-4 days in a well lit warehouse, may be more suitable. It should also be noted that the above figures indicate the theoretical minimum storage time for an unobscured bottle. Often the beer bottle is held in a holder or case when stored over longer times, thus storage times of several months could be achieved without any sign of lightstruck flavour. The actual minimum storage time during long time storage will also be longer since some of the generated MBT will deteriorate over time.

The beer bottles 50 may be fully or largely transparent for all wavelengths, i.e. having a filter characteristic similar to the inner layer designated numeral 20 of FIG. 1. Alternatively, the beer bottles 50 may be of the standard green or brown type. Yet alternatively, the beer bottles 50 may be of the type described in connection with FIGS. 1-3 above. In case a similar optical filter characteristic is chosen for the transparent surface 52 and for the bottles 50, the contents of the bottle 50 may be observed from the outside without opening the door 42 of the refrigerator 34. This may be convenient for a presumptive customer observing the beverage bottles 50 from the outside.

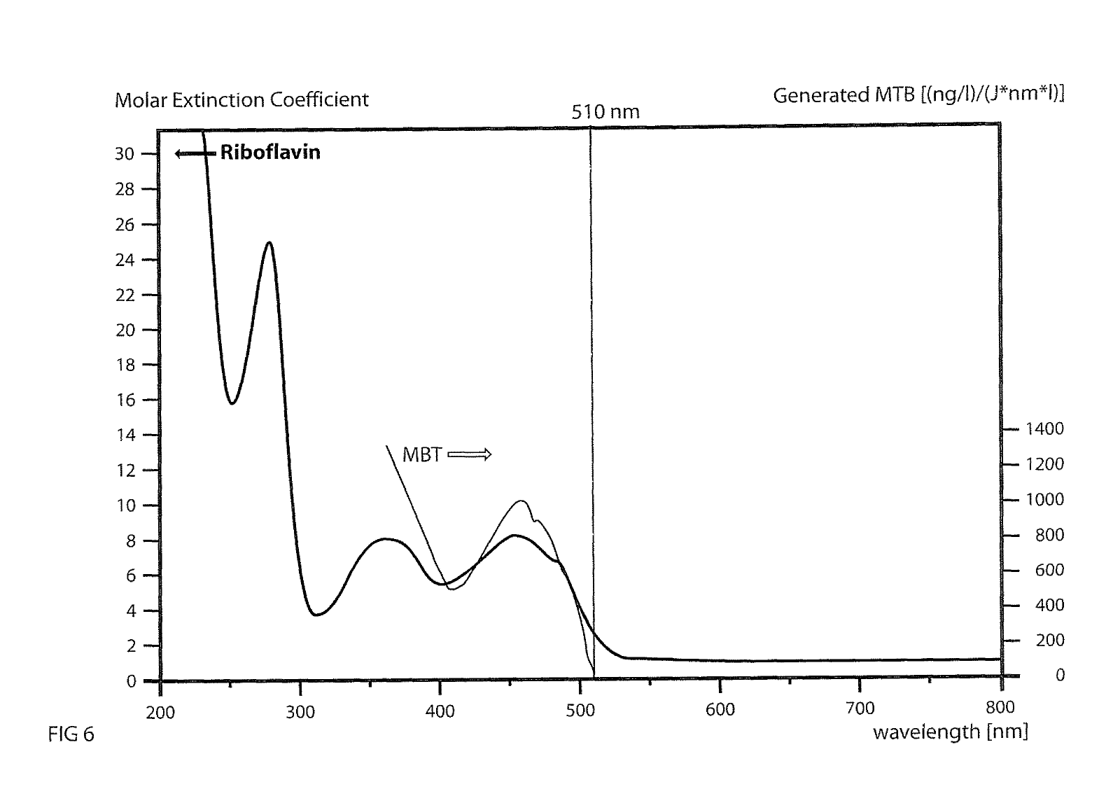

FIG. 6 shows a diagram containing graphic plots of the result of experiments performed by the applicant on the molar extinction coefficient for riboflavin shown in the first graph (thick line) and the amount of generated MBT shown in the second graph (thin line), for different wavelengths of light (nm range). The experiments have been performed by using a beer of the pilsner kind produced by the applicant company. The molar extinction coefficient is a measure of how well a material absorbs light. It can be clearly seen from the first graph that riboflavin does absorb very little light at wavelengths above 510 nm. Below 510 nm the absorption coefficient increases rapidly. The absorption graph below 510 nm forms four distinctive peaks, being at approximately 450 nm (440 nm-460 nm), 360 nm (350 nm -370 nm), 260 nm (250 nm-270 nm) and 220 nm (210 nm-230 nm), respectively. The 450 nm peak is due to S1*, the 360 nm peak is due to S2*, the 270 nm peak is due to S3* and the 220 nm peak is due to S4*.

In the second graph the generation of MBT in (ng/l)/(J*nm*l) is shown. Only the visible spectrum has been investigated. Surprisingly, it has been discovered that no measurable amount of MBT has been detected when the beer was irradiated by light having wavelengths above 510 nm. Below 510 nm the generated MBT was measureable. From the graph it can also be seen that the generation of MBT increases dramatically already at some nm below 510 nm. Previous investigations have determined the limit to be around 500 nm. The present investigation show that, due to the very sharp increase, the protective optical filter characteristic must be manufactured with much greater accuracy than previously assumed. A filter being transmissive at 510 nm would, in particular at sunny locations, prove to be insufficient for protecting the beer. The applicant company has therefore come to the conclusion that 510 nm must be determined to be a critical limit, and consequently the beer should be well protected to all wavelengths below 510 nm.

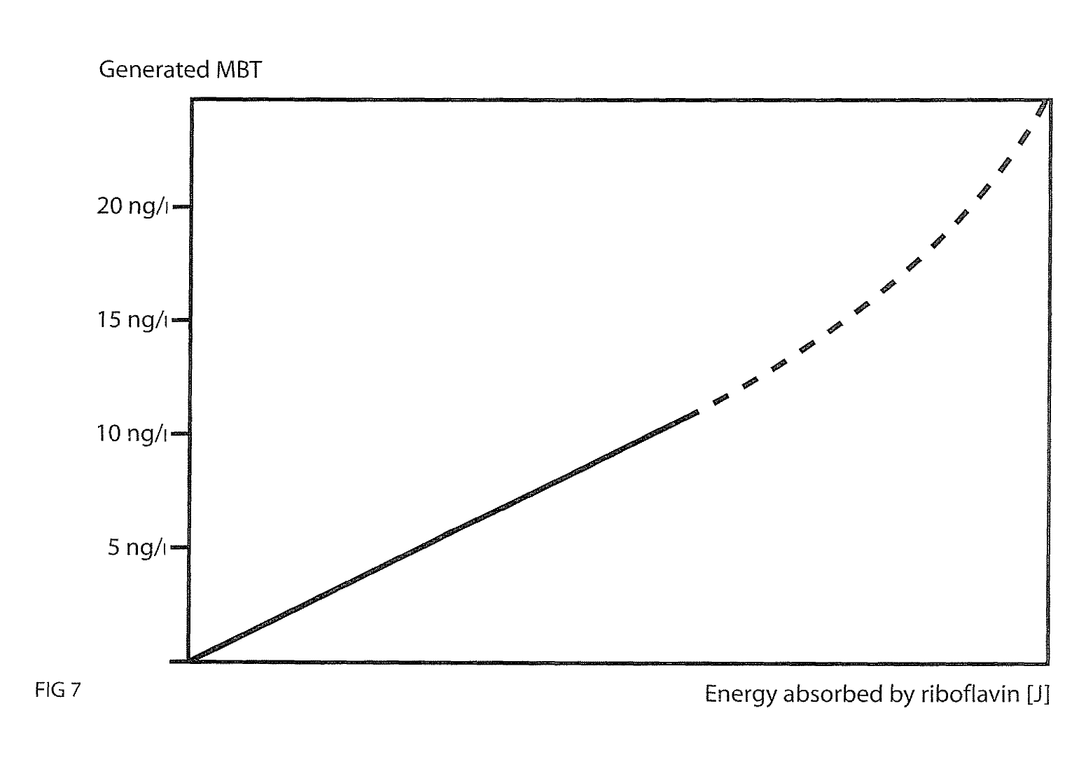

FIG. 7 shows a diagram of the relationship between the generated of MBT and the energy absorbed by riboflavin during light exposure. As shown in the diagram, the generation of MBT has been experimentally found to be directly proportional to the energy absorbed by riboflavin at any wavelength from 350 nm to 800 nm. This linear relation has been experimentally confirmed for low levels of MBT and low amounts of energy absorbed corresponding to levels of MBT up to about 10 ng/l, which is the determined critical limit for detection of professional beer tasters. The above experimental results shown in FIG. 7 proves that Riboflavin is the only relevant photo sensitizer in beer. The experiment was performed using a beer of the type pilsner and light of wavelenghts between 350 nm and 800 nm. It is suspected that the generation of MBT increases exponentially when the light exposure increases further and the concentration of MBT is above 10 ng/l.

All reactions must be controlled by only one excited species, which must then be the lowest energy common denominator, i.e. the first triplet T1*. This is in concurrence with Jablonsky rules. The absorption peaks at S2*, 83* and S4* all interconvert by non-radiative processes to S1*, which then makes the intersystem crossing to T1* with a high quantum efficiency (phi=0.67). S1* cannot be formed at wavelengths longer than 510nm.

Although the present invention has been described above with reference to specific embodiments, it is of course to be contemplated that numerous modifications may be deduced by a person having ordinary skill in the art and modifications readily perceivable by a person having the ordinary skill in the art is consequently to be construed part of the present invention as defined in the appending claims.

### LIST OF PARTS WITH REFERENCE TO THE FIGURES

10. Beer bottle according to the invention
12. Cap
14. Beer
16. Head space
18. Inner wall
20. Outer wall
24. Beverage case
26. Bottom wall
28. Sidewall
30. Standard beer bottle
32. Packaging film
34. Refrigerator
36. Top wall
38. Bottom wall
40. Sidewall
42. Door
46. Light source
48. Shelf
50. Beer bottles
52. Transparent surface (of the door)

1-15. (canceled)

16. A bottle, container or beverage glass for containing a hops-based beverage having a concentration between 10 μg/l and 10 mg/l of Riboflavin, said bottle, container or beverage glass being at least partially transparent or translucent to visible light and having an optical filter characteristic reducing light transmission of wavelengths between 200 nm and 510 nm to a level preventing generation of more than a tasteable concentration of MBT in said beverage through photochemical reactions and photochemically initiated auto-catalytic reactions involving said Riboflavin, said tasteable concentration being between 1 ng/l and 35 ng/l.

17. The bottle, container, or beverage glass according to claim 16, wherein generation of more than a tasteable concentration of MBT in said beverage is prevented when said bottle, container, or beverage glass is irradiated by sunlight having an intensity of 1 kW/m² during a time-period of at least 15 minutes.

18. The bottle, container, or beverage glass according to claim 17, wherein generation of more than a tasteable concentration of MBT in said beverage is prevented when said bottle, container, or beverage glass, subsequent to being irradiated by sunlight, is stored in a non-irradiated location for at least 1 hour.

19. The bottle, container or beverage glass according to claim 16, wherein said bottle, container or beverage glass comprises an outer wall having an inwardly facing surface, and an inner wall constituting a coating of said inwardly facing surface, said outer wall being at least partially transparent or translucent and at least substantially rigid, said inner wall being at least partially transparent or translucent and having said optical filter characteristic.

20. The bottle, container or beverage glass according to claim 16, wherein said bottle, container or beverage glass comprises an inner wall having an outwardly facing surface, and an outer wall constituting a coating of said outwardly facing surface, said inner wall being at least partially transparent or translucent and at least substantially rigid, said outer wall being at least partially transparent or translucent and having said optical filter characteristics.

21. The bottle, container, or beverage glass according to claim 16, wherein said bottle, container, or beverage glass allows light transmission of wavelengths between 200 nm and 510 nm, at a transmission ratio of no more than 10%.

22. The bottle, container, or beverage glass according to claim 16, wherein said bottle, container, or beverage glass allows light transmission of at least one wavelength between 510 nm and 750 nm, at a relative transmission ratio of at least 50% as compared to the transmission of said at least one wavelength through air.

23. A hops-based beverage having a concentration between 10 μg/l and 10 mg/l of Riboflavin, said beverage being at least partially transparent or translucent to visible light and including a constituent having an optical filter characteristic reducing light transmission of wavelengths between 200 nm and 510 nm to a level preventing generation of more than a tasteable concentration of MBT in said beverage through photochemical reactions and photochemically initiated auto-catalytic reactions involving said Riboflavin, said tasteable concentration being between 1 ng/l and 35 ng/l.

24. The beverage according to claim 23, wherein generation of more than a tasteable concentration of MBT in said beverage is prevented when said beverage is irradiated by sunlight having an intensity of 1 kW/m² during a time-period of at least 15 minutes.

25. The beverage according to claim 24, wherein generation of more than a tasteable concentration of MBT in said beverage is prevented when said beverage, subsequent to being, irradiated by sunlight, is stored in a non-irradiated location for at least 1 hour.

26. The beverage according to claim 23, wherein said beverage allows light transmission of wavelengths between 200 nm and 510 nm, at a transmission ratio of no more than 10%.

27. The beverage according to claim 23, wherein said beverage allows light transmission of at least one wavelength between 510 nm and 750 nm, at a relative transmission ratio of at least 50% as compared to the transmission of said at least one wavelength through air.

28. A refrigerator for storing hops-based beverages contained in beverage bottles, said refrigerator having a door and an internal light source, said beverage having a concentration between 10 μg/l and 10 mg/l of Riboflavin, said door and light source being at least partially transparent or translucent to visible light and having an optical filter characteristic reducing light transmission of wavelengths between 200 nm and 510 nm to a level preventing generation of more than a tasteable concentration of MBT in said beverage through photochemical reactions and photochemically initiated auto-catalytic reactions involving said Riboflavin, said tasteable concentration being between 1 ng/l and 35 ng/l.

29. The refrigerator according to claim 28, wherein generation of more than a tasteable concentration of MBT in said beverage is prevented when said refrigerator is irradiated by sunlight having an intensity of 1 kW/m² during a time-period of at least 15 minutes.

30. The refrigerator according to claim 29, wherein generation of more than a tasteable concentration of MBT in said beverage is prevented when said refrigerator, subsequent to being irradiated by sunlight, is stored in a non-irradiated location for at least 1 hour.

31. The refrigerator according to claim 28, wherein said refrigerator allows light transmission of wavelengths between 200 nm and 510 nm, at a transmission ratio of no more than 10%.

32. The refrigerator according to claim 28, wherein said refrigerator allows light transmission of at least one wavelength between 510 nm and 750 nm, at a relative transmission ratio of at least 50% as compared to the transmission of said at least one wavelength through air.

33. A packaging film for protecting hops-based beverages being stored in beverage bottles, said beverage having a concentration between 10 μg/l and 10 mg/l of Riboflavin, said packaging film being at least partially transparent or translucent to visible light and having an optical filter characteristic reducing light transmission of wavelengths between 200 nm and 510 nm to a level preventing generation of more than a tasteable concentration of MBT in said beverage through photochemical reactions and photochemically initiated auto-catalytic reactions involving said Riboflavin, said tasteable concentration being between 1 ng/l and 35 ng/l.

34. The packaging film according to claim 33, wherein generation of more than a tasteable concentration of MBT in said beverage is prevented when said packaging film is irradiated by sunlight having an intensity of 1 kW/m² during a time-period of at least 15 minutes.

35. The packaging film according to claim 34, wherein generation of more than a tasteable concentration of MBT in said beverage is prevented when said packaging film, subsequent to being irradiated by sunlight, is stored in a non-irradiated location for at least 1 hour.

36. The packaging film according to claim 33, wherein said packaging film allows light transmission of wavelengths between 200 nm and 510 nm, at a transmission ratio of no more than 10%.

37. The packaging film according to claim 33, wherein said packaging film allows light transmission of at least one wavelength between 510 nm and 750 nm, at a relative transmission ratio of at least 50% as compared to the transmission of said at least one wavelength through air.
